(19) United States
(12) Patent Application Publication
(10) Pub. No.: US 2017/0227704 A1
(43) Pub. Date: Aug. 10, 2017

(54) Back Plate Assembly, Backlight Module, And Display Device

(71) Applicant: Shenzhen China Star Optoelectronics Technology Co. Ltd., Shenzhen, Guangdong (CN)

(72) Inventors: Oehua LI, Shenzhen, Guangdong (CN); Yuchun HSIAO, Shenzhen, Guangdong (CN); Gang YU, Shenzhen, Guangdong (CN)

(73) Assignee: Shenzhen China Star Optoelectronics Technology Co. Ltd., Shenzhen, Guangdong (CN)

(21) Appl. No.: 14/904,473

(22) PCT Filed: Dec. 24, 2015
(86) PCT No.: PCT/CN2015/098742

§ 371 Date: Jan. 12, 2016

(30) Foreign Application Priority Data
Nov. 12, 2015 (CN) 201510771643.0

(51) Int. Cl. F21V 8/00

(52) U.S. Cl. CPC G02B 6/0088

(57) ABSTRACT

The back plate assembly contains a back plate and a reinforcing plate fixed to a back side of the back plate. The reinforcing plate has a hollowed out pattern with a number of connected reinforcing ribs. A backlight module and a display device incorporating the back plate assembly are also disclosed. The reinforcing plate is designed and manufactured separately and then fixed to the back plate. The reinforcing ribs and engraved openings are integrated on the reinforcing plate, achieving superior capability to withstand deformation and flexibility in customization to suit the need and appearance of various backlight modules and display devices.

### BACKGROUND OF THE INVENTION

1. Field of the Invention

The present invention relates to display technologies, and in particular to a back plate assembly, a backlight module, and a display device.

2. The Related Arts

Liquid crystal display (LCD) devices are widely applied to various electronic appliances. As these appliances are required to have smaller thickness, the backlight module, as a vital component of a LCD device, has to be much thinner as well.

A backlight module usually contains a light guide plate and a back plate behind the light guide plate. Under the trend of reduced thickness, the back plate naturally has to be thinner. This leads to reduced rigidity to the back plate. Currently a known method in reinforcing the rigidity of the back plate is to affix a number of ribs to the back plate. Despite their effectiveness, the ribs seriously affect the appearance of the back plate and the display device. In addition, the ribs are not tightly integrated, resulting in increased thickness to the backlight module and the display device.

### SUMMARY OF THE INVENTION

To obviate the shortcoming of the prior art, the present invention provides a highly rigid and visually appealing back plate assembly.

To achieve the objective, the present invention teaches the following technical solutions.

A back plate assembly contains a back plate and a reinforcing plate fixed to a back side of the back plate. The reinforcing plate has a hollowed out pattern with a number of connected reinforcing ribs.

The reinforcing plate is made of metal.

Alternatively, the reinforcing plate is made of carbon fiber, reinforced glass, or ceramics.

The reinforcing plate is symmetric about a vertical line across two longer edges in the middle of the reinforcing plate.

The hollowed out pattern has at least a pair of first openings and a number of pairs of second openings symmetrically arranged about the vertical line. A number of second openings are positioned at intervals along a circumference of each first opening, and the first openings are larger than the second openings.

The hollowed out pattern further has a third opening positioned between the pair of the first openings.

Alternatively, the reinforcing plate contains a number of sub-plates pieced together. The first openings are jointly formed by the sub-plates.

Alternatively, the hollowed out pattern fans radially outward from a bottom center point on the symmetric axis.

Another objective of the present invention is to provide a backlight module incorporating the above-described back plate assembly. The back plate assembly is configured to a back side of the backlight module.

Yet another objective of the present invention is to provide a display device incorporating the above-described back plate assembly. The back plate assembly is configured to a back side of the display device.

According to the present invention, the reinforcing plate is designed and manufactured separately and then fixed to the back plate. The reinforcing ribs and engraved openings are integrated on the reinforcing plate, achieving superior capability to withstand deformation and flexibility in customization to suit the need and appearance of various backlight modules and display devices.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a perspective break-down diagram showing a display device according to a first embodiment of the present invention;

FIG. 2 is a perspective diagram showing a

FIG. 3 is a rear-view diagram showing the display device of FIG. 1;

FIG. 4 is a rear-view diagram showing the display device of FIG. 1 where a reinforcing plate has a different pattern;

FIG. 5 is a rear-view diagram showing a display device according to a second embodiment of the present invention;

FIG. 6 is a perspective diagram showing the installation of an reinforcing plate according to a third embodiment of the present invention; and

FIG. 7 is a rear-view diagram showing a display device according to the third embodiment of the present invention.

### DETAILED DESCRIPTION OF THE PREFERRED EMBODIMENTS

### First Embodiment

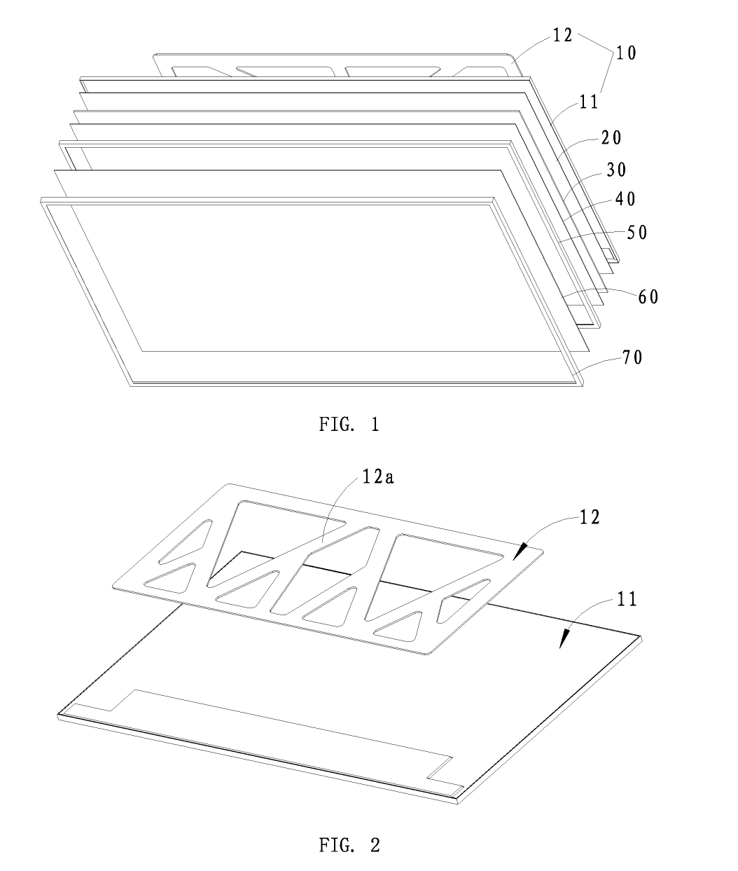

As illustrated in FIG. 1, a display device according to a first embodiment of the present invention contains a back plate assembly 10, a reflection plate 20, a light guide plate 30, an optical film set 40, a plastic frame 50, a liquid crystal panel 60, and a front frame 70, arranged sequentially from a front side to a back side of the display device. The back plate assembly 10, the reflection plate 20, the light guide plate 30, the optical film set 40, and the plastic frame 50 jointly form a backlight module. The liquid crystal panel 60 is configured to a front side of the plastic frame 50 and is surrounded by the front frame 70 for protection and positioning.

As illustrated in FIG. 2, the back plate assembly 10 contains a back plate 11, and a thin reinforcing plate 12 attached to a back side of the back plate 11 oppositely to the light guide plate 30. The reinforcing plate 12 has a number of engraved openings so as to form a number of reinforcing ribs 12a.

The reinforcing plate 12 is made of a material of high rigidity, such as metal, carbon fiber, reinforced glass, and ceramics, whose elastic modulus is above 200 GPa so that the reinforcing plate 12 is capable of withstanding deformation. The reinforcing plate 12 is attached to the back plate 11 by bolts, adhesives, or adhesive tapes so that it can be replaced and customized conveniently.

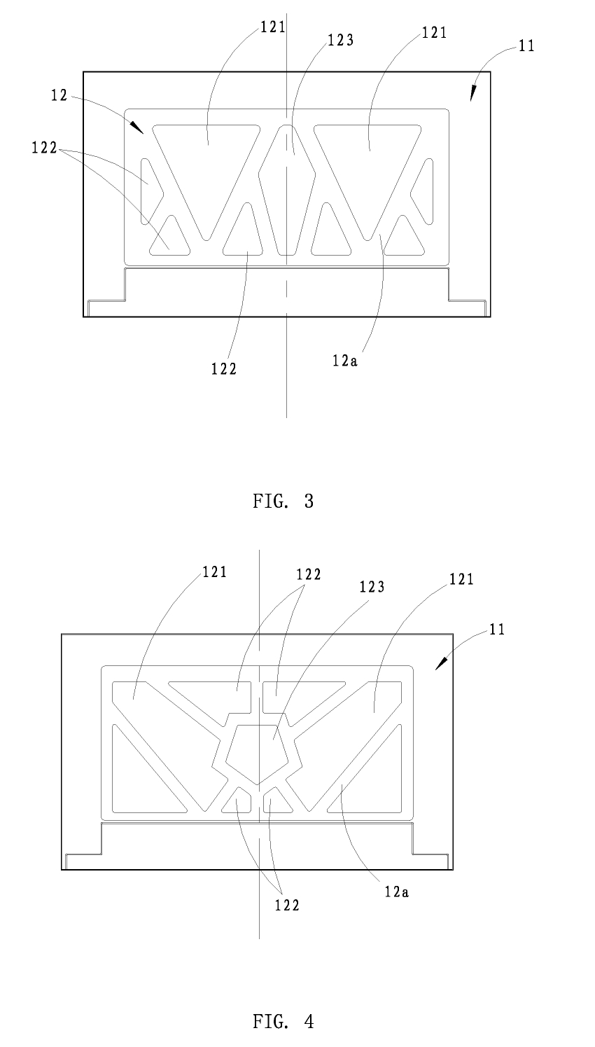

As illustrated in FIG. 3, the reinforcing plate 12 is positioned so that a vertical line across its two longer edges dividing the reinforcing plate 12 into two equal halves (hereinafter, the symmetric axis) is aligned with a same vertical line of the back plate 11. The hollowed out pattern of the reinforcing plate 12 and the reinforcing ribs 12a are also symmetric about the symmetric axis. Therefore, the back plate 11 is provided with uniform support from the reinforcing plate 12.

Specifically, the reinforcing plate 12 has at least a pair of first openings 121 and a number of pairs of second openings 122 symmetrically arranged about the symmetric axis. The first and second openings 121 and 122 are of different polygonal shapes and the first openings 121 are larger than the second openings 122. The first and second openings 121 and 122 are configured so that, along a circumference of each first opening 121, a number of second openings 122 are positioned at intervals, and the reinforcing ribs 12a are all connected and most of them are formed slantwise. By arranging the reinforcing ribs 12a along various directions, the back plate 11 is guaranteed to have superior capability to withstand deformation.

The reinforcing plate 12 has an additional third opening 123 between the pair of the first openings 121.

As illustrated in FIG. 3, the third opening 123 is a polygon symmetric about the symmetric axis in the center of the reinforcing plate 12. There are two triangular first openings 121 at the third openings 123's lateral sides, respectively. The second openings 122 are of smaller triangular shapes. FIG. 4 is another arrangement of the hollowed out pattern of the present embodiment. As illustrated, the third opening 123 is a pentagon symmetric about the symmetric axis in the center of the reinforcing plate 12. There are two polygonal first openings 121 at the third openings 123's lateral sides, respectively. The second openings 122 are of smaller and different polygonal shapes.

### Second Embodiment

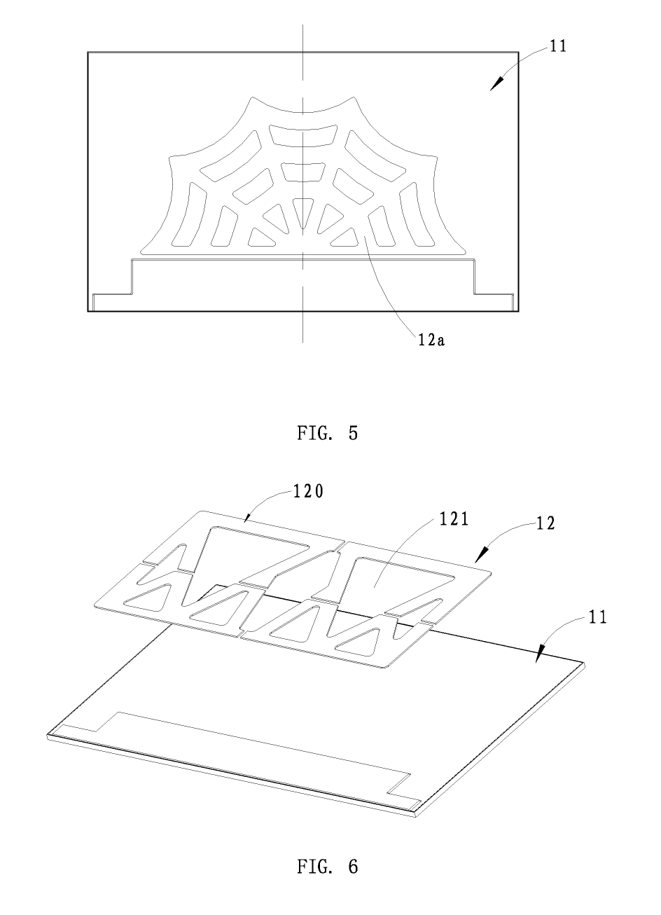

As shown in FIG. 5, the reinforcing plate 12 of a second embodiment of the present invention has its hollowed out pattern, in addition to be symmetric about the symmetric axis, fanned radially outward from a bottom center point on the symmetric axis. The reinforcing ribs 12a are formed between the hollowed out openings, and are also symmetric about the symmetric axis, thereby providing a same capability to withstand deformation.

### Third Embodiment

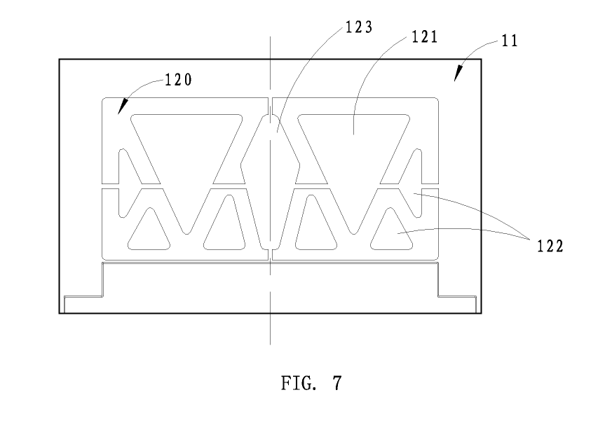

As illustrated in FIGS. 6 and 7, the reinforcing plate 12 of a third embodiment of the present invention is formed by piecing together a number of sub-plates 120. An upper sub-plate 120 and a lower sub-plate 120 are joined vertically into a first lateral piece and to form a first opening 121 and at least a second opening 122 on the first lateral piece. A third opening 123 is formed by joining laterally a first lateral piece and a second lateral piece. The pieced-together reinforcing plate 12 is then attached to a back side of the back plate 11 by the above-mentioned means. This embodiment is suitable and practical when the reinforcing plate 12 cannot be integrally formed due to the material used or due to the dimension being too large.

The present invention has the reinforcing plate designed and manufactured separately and then fixed to the back plate. The reinforcing ribs and engraved openings are integrated on the reinforcing plate, achieving superior capability to withstand deformation and flexibility in customization to suit the need and appearance of various backlight modules and display devices.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A back plate assembly, comprising:
a back plate; and
a reinforcing plate fixed to a back side of the back plate having a hollowed out pattern with a plurality of connected reinforcing ribs.

2. The back plate assembly as claimed in claim 1, wherein the reinforcing plate is made of metal.

3. The back plate assembly as claimed in claim 1, wherein the reinforcing plate is made of carbon fiber, reinforced glass, or ceramics.

4. The back plate assembly as claimed in claim 1, wherein the reinforcing plate is symmetric about a vertical line across two longer edges in the middle of the reinforcing plate.

5. The back plate assembly as claimed in claim 4, wherein the hollowed out pattern has at least a pair of first openings and a plurality of pairs of second openings symmetrically arranged about the vertical line; a plurality of second openings are positioned at intervals along a circumference of each first opening; and the first openings are larger than the second openings.

6. The back plate assembly as claimed in claim 5, wherein the hollowed out pattern further has a third opening positioned between the pair of the first openings.

7. The back plate assembly as claimed in claim 4, wherein the reinforcing plate comprises a plurality of sub-plates pieced together; and the first openings are jointly formed by the sub-plates.

8. The back plate assembly as claimed in claim 4, wherein the hollowed out pattern fans radially outward from a bottom center point on the symmetric axis.

9. A backlight module comprising a back plate assembly wherein the back plate assembly comprises:
a back plate; and
a reinforcing plate fixed to a back side of the back plate having a hollowed out pattern with a plurality of connected reinforcing ribs.

10. The backlight module as claimed in claim 9, wherein the reinforcing plate is symmetric about a vertical line across two longer edges in the middle of the reinforcing plate.

11. The backlight module as claimed in claim 9, wherein the hollowed out pattern has at least a pair of first openings and a plurality of pairs of second openings symmetrically arranged about the vertical line; a plurality of second openings are positioned at intervals along a circumference of each first opening; and the first openings are larger than the second openings.

12. The backlight module as claimed in claim 11, wherein the hollowed out pattern further has a third opening positioned between the pair of the first openings.

13. The backlight module as claimed in claim 10, wherein the reinforcing plate comprises a plurality of sub-plates pieced together; and the first openings are jointly formed by the sub-plates.

14. The backlight module as claimed in claim 10, wherein the hollowed out pattern fans radially outward from a bottom center point on the symmetric axis.

15. A display device comprising a backlight module wherein the backlight module comprises a back plate assembly; and the back plate assembly comprises:
a back plate; and
a reinforcing plate fixed to a back side of the back plate having a hollowed out pattern with a plurality of connected reinforcing ribs.

16. The display device as claimed in claim 15, wherein the reinforcing plate is symmetric about a vertical line across two longer edges in the middle of the reinforcing plate.

17. The display device as claimed in claim 15, wherein the hollowed out pattern has at least a pair of first openings and a plurality of pairs of second openings symmetrically arranged about the vertical line; a plurality of second openings are positioned at intervals along a circumference of each first opening; and the first openings are larger than the second openings.

18. The display device as claimed in claim 17, wherein the hollowed out pattern further has a third opening positioned between the pair of the first openings.

19. The display device as claimed in claim 16, wherein the reinforcing plate comprises a plurality of sub-plates pieced together; and the first openings are jointly formed by the sub-plates.

20. The display device as claimed in claim 16, wherein the hollowed out pattern fans radially outward from a bottom center point on the symmetric axis.
